(19) United States
(12) Patent Application Publication
(10) Pub. No.: US 2011/0091575 A1
(43) Pub. Date: Apr. 21, 2011

(54) STRATEGIES FOR REDUCING LEACHING OF WATER-SOLUBLE METAL BIOCIDES FROM TREATED WOOD PRODUCTS

(76) Inventors: Kimberly S. Hayson, Redhouse, WV (US); William C. Hoffman, Decatur, IL (US); Albert F. Joseph, Charleston, WV (US); Brian T. Keen, Pinch, WV (US)

(21) Appl. No.: 12/747,245

(22) PCT Filed: Dec. 12, 2008
(86) PCT No.: PCT/US08/13626

§ 371 Date: Nov. 16, 2010

Related U.S. Application Data
(60) Provisional application No. 61/007,614, filed on Dec. 13, 2007.

(51) Int. Cl. A01N 59/20; A01P 15/00

(52) U.S. Cl. 424/634; 424/630

(57) ABSTRACT

Strategies that dramatically reduce leaching of water-soluble metal-containing biocides from treated biodegradable products. Aqueous, preservative compositions of the present invention incorporate one or more water-soluble metal species having biocidal activity and one or more agents that increase the leaching resistance of these metal species when impregnated into biodegradable products. Using one or more of these agents allows usage rates of the biocide impregnants to be dramatically lowered at the time of impregnation of the products. Because less of the metal biocide leaches in the presence of these agent(s), less biocide has to be added in order to meet desired loading goals. Generally, an agent of the present invention that reduces leaching of metal biocides is water soluble, is substantially nonionic in aqueous media, has a molecular weight greater than about 100, and has a vapor pressure less than that of water at standard temperature. Preferred agents are those including at least 10 weight percent, more preferably at least 16 weight percent, and even more preferably at least 20 weight percent oxygen. Examples of these preferred agents include (poly)ethers and/or nonionic surfactants including one or more oxyalkylene units in the backbone and/or as substituents of the molecule.

### FIELD OF THE INVENTION

The present invention relates to metal-containing preservative compositions useful for protecting substrates such as wood, other cellulosic products, starch-based products, and the like that are vulnerable to decay due to insects, fungi, microbes, and the like, wherein at least one metal constituent of the compositions functions as a biocide. More particularly, the present invention relates to such preservative compositions that include agents that help reduce the tendency of the water-soluble, metal biocides, particularly water-soluble complexes of these metal biocides, to leach from the treated substrates.

### BACKGROUND OF THE INVENTION

Substrates such as wood, starch-based, and other biodegradable products used in interior or exterior applications can be vulnerable to attack by insects, fungi, microbes, and the like. To prevent decay that tends to result from these attacks, such substrates may be treated with preservatives to protect against decay and increase longevity. Historically, one widely used preservative composition is known by the CCA designation. This designation stands for chromated copper arsenate. CCA compositions were widely used to treat wood products, e.g., Southern Yellow Pine, used for decks, fencing, landscape timbers, and the like.

CCA compositions provide excellent protection against decay. However, relatively recently, health and safety concerns have been raised concerning the arsenic and chromium content of these compositions. Consequently, EPA regulatory guidelines caused CCA usage for residential applications to stop on Jan. 1, 2004. As a result, the industry has developed and continues to develop new preservatives as substitutes for CCA compositions. Uncovering effective substitutes that are chromium and arsenic free has been challenging.

One newer class of copper-based preservatives uses a form of complexed copper that is water-soluble. In many embodiments, the copper is complexed with complexing agents such as an alkanolamine. Examples of preservatives that contain copper complexes include copper polyaspartic acid, alkaline copper quaternary (ACQ), copper azole, copper boron azole, ammoniacal copper citrate, copper bis(dimethyldithiocarbamate), and copper ethanolamine carbonate. Commonly, all these have a nitrogen base that complexes copper and carbonate ions to stabilize the resultant complex. Preservative compositions incorporating copper complexed with alkanolamine are referred to by the designation copper-amine and currently dominate the preservative market for residential lumber applications.

Compared to biodegradable products treated with CCA materials, biodegradable products treated with these newer copper complex-based materials suffer higher copper losses in the field. Due to the water solubility of the complexes, the copper tends to leach more readily from the treated biodegradable products when exposed to rain or other water. Although copper is not very toxic to mammals, copper can be a potent aquatic biocide. Additionally, the expectation that copper losses will occur due to leaching causes treatments to be made with larger amounts of copper to accommodate these expected losses. This not only would exacerbate exposure of aquatic environments but also is costly and wasteful. It would be highly desirable to find strategies to reduce leaching in order to use copper-amine preservatives near aquatic species and in order to use copper supplies more efficiently.

### SUMMARY OF THE INVENTION

Significantly, the present invention provides strategies that dramatically reduce leaching of water-soluble metal-containing biocides from treated substrates subject to decay, such as wood, starch-based, and other biodegradable products. Aqueous, preservative compositions of the present invention incorporate one or more water-soluble metal species having biocidal activity and one or more agents that improve the leaching resistance of these metal species when impregnated into biodegradable products. Using one or more of these agents allows usage rates of the biocide impregnants to be dramatically lowered at the time of impregnation of the products. Because less of the metal biocide leaches in the presence of these agent(s), less metal biocide has to be added in order to meet desired loading goals (Loading goals are often expressed in the industry on the basis of pounds of impregnant per cubic foot of substrate, abbreviated as “pcf”). Conventionally, in contrast, substantially more metal biocide would be added to account for the substantial amount of metal biocide expected to leach. These agents also help to reduce the amount of metal biocide that leaches into the environment.

An agent of the present invention that reduces leaching of metal biocides has a combination of characteristics that synergistically combines to more tenaciously help hold impregnated metal biocides in wood products. Generally, an agent of the present invention that reduces leaching of metal biocides is water soluble, is substantially nonionic in aqueous media, has a molecular weight greater than about 100, and has a vapor pressure less than that of water. Surprisingly, even though water-soluble themselves, it has been discovered that compounds having a combination of at least these four characteristics help reduce leaching of water-soluble, complexed metal biocides from impregnated, biodegradable substrates. As used herein, molecular weight refers to the weight average molecular weight unless otherwise expressly noted.

Preferred agents that reduce leaching of metal biocides are those including at least about 4 weight percent, more preferably about 4 to about 55 weight percent, and even more preferably about 20 to about 45 weight percent oxygen. Examples of these preferred agents include (poly)ethers and/or nonionic surfactants including one or more oxyalkylene units in the backbone and/or as substituents of the molecule. In some embodiments, the one or more agents that help to improve leaching resistance comprise a combination of a (poly)ether and a nonionic surfactant incorporating one or more of such oxyalkylene groups, respectively.

Some embodiments also may involve incorporating the metal biocide into the preservative compositions in the form of a water-soluble complex. Inclusion in a complex helps to solubilize and/or ensure that the metal species remains in solution, or remains more easily dispersed in the composition, at least until the desired 30, preserving treatment is carried out. Forming such a complex is conveniently achieved by reacting a source including the metal biocide with a suitable complexing agent. Additional, optional ingredients, described further below, may be included in the compositions to further enhance the performance of the compositions.

In one aspect, the present invention relates to an aqueous preservative composition for treating biodegradable substrates. The composition is derived from ingredients comprising: a source of a metal biocide; an amount of a complexing agent effective to form a water-soluble complex with at least a portion of the metal biocide; and at least one water soluble, substantially nonionic agent having a molecular weight of at least about 100 and having vapor pressure less than that of water, said composition including an amount of the agent effective to reduce leaching of the complexed metal biocide from a biodegradable substrate impregnated with the composition relative to an otherwise identical composition lacking the agent.

In another aspect, the present invention relates to an aqueous preservative composition for treating biodegradable substrates, derived from ingredients comprising a source of a metal biocide; a first water-soluble, substantially nonionic agent having a molecular weight of at least about 100 and having a vapor pressure less than that of water, said composition including an amount of the first agent effective to reduce leaching of the metal biocide from a biodegradable substrate impregnated with the composition relative to an otherwise identical composition lacking the agent; and a second water soluble, substantially nonionic agent comprising a nonionic surfactant, wherein the weight ratio of the water soluble, substantially nonionic first agent to the nonionic surfactant is greater than 1.

In another aspect, the present invention relates to a method of testing leaching characteristics of a biodegradable substrate treating composition, comprising the steps of:
a) using a treating composition to impregnate a biodegradable substrate, said composition comprising a transition metal;
b) at least partially drying the impregnated substrate;
c) causing at least a portion of one component of the treating composition to be fixed to the substrate;
d) immersing the impregnated substrate in an aqueous medium;
e) during at least a portion of the immersing step, agitating the aqueous medium; and
f) determining information indicative of an amount of the transition metal that leached from the substrate during at least a portion of the immersion.

In another aspect, the present invention relates to a method of treating a biodegradable substrate, comprising the steps of:
a) providing ingredients comprising a (poly)ether;
b) causing the (poly)ether to be incorporated into a wood treating composition also derived from ingredients comprising Cu and a complexing agent;
c) after adding the (poly)ether, causing the composition to be used to treat the biodegradable substrate.

In another aspect, the present invention relates to a method of treating a biodegradable substrate, comprising the steps of:
a) providing ingredients comprising a (poly)ether and a nonionic surfactant, wherein the weight ratio of the (poly)ether to the nonionic surfactant is greater than 1;
b) causing the (poly)ether and the nonionic surfactant to be incorporated into a preservative composition also incorporating ingredients comprising Cu;
c) after adding the (poly)ether, causing the composition to be used to treat the biodegradable substrate.

In another aspect, the present invention relates to a method of testing leaching characteristics of a biodegradable substrate treating composition, comprising the steps of:
a) using a treating composition to impregnate a biodegradable substrate, said composition comprising a transition metal and a water soluble agent having a vapor pressure less than water and a molecular weight greater than about 100 and optionally including from about 4 to about 55 weight percent oxygen;
b) at least partially drying the impregnated substrate;
c) causing at least a portion of one component of the treating composition to be fixed to the substrate;
d) immersing the impregnated substrate in an aqueous medium
e) during at least a portion of the immersing step, agitating the aqueous medium; and
f) determining information indicative of an amount of the transition metal that leached from the substrate during at least a portion of the immersion.

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

Examples of metals that can be used in the preservative compositions of the present invention include transition metal elements including the lanthanide and actinide series elements such as copper, strontium, barium, arsenic, antimony, bismuth, lead, gallium, indium, thallium, tin, zinc, chromium, cadmium, silver, gold, nickel, molybdenum, combinations of these, and the like. A preferred metal is copper. Due to present regulatory concerns it is desirable to limit or avoid the use of Cr and/or As in residential applications. Accordingly, the compositions of the invention are desirably at least substantially arsenic free, at least substantially chromium free, and/or at least substantially chromium and arsenic free. However, it is appreciated that the principles of the present invention would be useful to help reduce the leaching of Cr and/or As from biodegradable substrates such as wood products, and therefore could greatly ease regulatory concerns associated with the use of wood preservatives incorporating one or both of these additives in some applications.

In those embodiments in which the active metal biocide(s) are to be incorporated into a water soluble complex, the ingredients used to form the preservative compositions include a form of the one or more metal biocides that allow the metal to form a complex with the complexing agent in aqueous media. In these complexes, the metal ions source may be the pure metal, a metal ion, or a metal compound. In the case of copper, many suitable copper sources are known that readily react with a wide variety of copper complexing agents in aqueous media. These could include under appropriate reaction conditions cuprous oxide, cupric oxide, copper hydroxide, copper carbonate, copper basic carbonate, copper oxychloride, copper-8-hydroxyquinolate, copper dimethyldithiocarbamate, copper omadine, copper borate, copper metal byproducts, copper sulfate, copper fluoroborate, copper fluoride, copper formate, copper acetate, copper bromide, copper iodide, copper basic phosphate, copper basic phosphor-sulfate, copper basic nitrate, combinations of these, and the like. Copper basic carbonate, which may be represented by the simplified formula Cu(OH)₂—CuCO₃, is an example of one preferred source of copper.

The weight percent of metal biocide incorporated into the composition may vary over a wide range. If too little is used, then the biocidal activity of the composition may be less than might be desired. If too much metal biocide is used, then the excess metal biocide exceeding the saturation level of the substrate for retaining the biocide will tend to be more prone to leaching. Consequently, using greater amounts of the metal biocide in excess of the saturation level might offer little, if any, extra biocidal protection due to leaching of the excess. Stated differently, using lesser amounts of metal biocide within the capacity of the substrate to more strongly retain the biocide would provide just as much biocidal protection as using greater amounts but without being wasteful.

In some instances, it may be desirable to initially formulate the composition in a more concentrated form to facilitate manufacturing, packaging, and shipping. The end user then would dilute the composition to the final desired concentration to treat wood products. Balancing such concerns, compositions of the present invention may include from about 0.02 to about 15 weight percent biocidal metal(s), more preferably 0.04 to about 11 weight percent metal(s) based on the total weight of the composition. Generally, weight percents higher than about 3 weight percent metal(s), more typically about 7 weight percent metal(s) represent more concentrated embodiments that might be diluted by the end user prior to a preservative treatment.

In calculating the weight percent metal(s) incorporated into a composition, only the weight of the metal(s) per se is/are used to make the calculation without inclusion of the weight of other species that might be included with the metal(s) in the metal source(s). For example, if 15 grams of copper basic carbonate deemed to have the simplified formula Cu(OH)₂—CuCO₃ is incorporated into a composition whose total weight is 100 g including the added copper basic carbonate, then the weight percent of copper in this composition is 8.6 weight percent.

In some embodiments, the complexing agent helps solubilize and/or disperse the metal biocide or metal biocide-containing species. The use of the complexing agent may be desirable even when the Cu is supplied from a highly water-soluble source inasmuch as the resultant complexes are more resistant to precipitation and/or settling during manufacture, packaging, storage, dilution with various water supplies, preserving treatments, and/or other handling. The use of complexing agents is a straightforward, economic way to solubilize the metal biocides in aqueous media and to facilitate a more uniform distribution of the metal biocide in the substrate.

The complexing agent is also referred to as a ligand, chelant, chelating agent, or sequestering agent in the field of coordination chemistry. The complexing agent is desirably one that bonds to the central metal-containing species, often an ion, through one or more atoms of the complexing agent. These bonds may be a combination of one or more different kinds of bonds such as coordination and/or ionic bonds. The bonds may be reversible or irreversible, depending upon factors including the metal species, the complexing agent, the reaction conditions used to form the complex, and the like.

A wide variety of complexing agents may be used in the practice of the present invention. These include organic acids such as aspartic acid, citric acid, and oxalic acid; ammonia; polyamine functional compounds such as ethylenediamine; nitrogen-containing alcohols such as alkanolamines; combinations of these and the like. Examples of alkanolamines include monoethanolamine; isopropanolamine; 1-1- or 1,2-diaminoethanol; diethanolamine; dimethylethanolamine; triethanolamine; aminoethylethanolamine; combinations of these; and the like. The alkanolamines are particularly preferred in complexes with copper. The complexing agent is used in an amount effective to form a complex with at least a portion of the metal biocide. More desirably, enough complexing agent is used to help ensure that at least substantially all of the metal biocide is complexed.

A problem with soluble or easily dispersed forms of metal biocides is that these may tend to more readily leach from treated, biodegradable substrates when exposed to rain or other sources of water. Advantageously incorporating a leaching-reducing agent of the present invention into the impregnation composition dramatically reduces such leaching. Generally, an agent of the present invention that reduces leaching of metal biocides is water soluble, is substantially nonionic in aqueous media, has a molecular weight (or a weight average molecular weight if the agent is present as a population distribution) greater than about 100, and has a vapor pressure less than that of water.

As used herein, water soluble means that a homogeneous solution may be prepared by dissolving 0.5 grams, 1.0 grams in some embodiments, and even 2.0 grams in some embodiments, of the agent(s) in 100 ml of distilled water, and then, when the resultant solution is stored at 25° C., at least 90% of the agent(s) remain in solution for at least two hours. When a single agent is to be used, the single agent to be used is dissolved in the water to assess water solubility. When a mixture of two or more agents are to be used in the treatment solution, an appropriate sample of the mixture in the intended proportions to be used is dissolved in the water to assess solubility.

Generally, molecular weight impacts the ability of an agent to protect against leaching. If the molecular weight is too low, e.g., below about 100, or even below about 80, a material may not protect against leaching at all and may even increase leaching. On the other hand, agents of the invention having a molecular weight above about 100 tend to provide greater leaching protection. Indeed, leaching protection tends to increase as molecular weight, or weight average molecular weight as appropriate, increases. This means that agents with higher molecular weights generally can be used at lower usage rates to provide comparable or better leaching protection than agents with lower molecular weight. Accordingly, a leaching reducing agent of the present invention desirably has a molecular weight (or weight average molecular weight, as appropriate) of at least 100, more desirably at least about 150, even more desirably at least about 200, and even more desirably at least about 500.

However, there tends to be a maximum molecular weight beyond which use of an agent may become impractical. For instance, if the agent is too large, the impregnation solution may gel or otherwise be too viscous and/or impregnation may become unduly difficult. Accordingly, it is preferred that an agent of the present invention has a molecular weight (or weight average molecular weight, if appropriate) of no more than about 100,000, desirably no more than about 50,000, more desirably no more than about 30,000.

The leaching-reducing agent of the present invention also has a vapor pressure less than that of water at standard temperature. This helps ensure that the agent evaporates more slowly than water during a drying phase after impregnation, during the course of manufacture, and/or after an impregnated wood product is exposed to water (e.g., rain or the like) during its service life. In other words, the agent, as an organic phase, tends to concentrate relative to water as the relatively more volatile water evaporates faster. Without wishing to be bound, it is believed that the relatively concentrated organic phase, due to partition coefficient effects, helps to reduce the propensity for complexed metal biocide to be solubilized in the water that may be present. This enhances the ability of the wood to retain the metal biocide relative to the water, reducing leaching that might otherwise occur. Stated schematically, both the wood and water compete for the metal biocide. Leaching may have a greater tendency to occur when water is a relatively stronger competitor. However, in the presence of the additives of the present invention, the biodegradable substrates are relatively stronger competitors than they would be in the absence of the additives, resulting in less leaching.

Desirably, preferred leaching-reducing agents of the present invention have a vapor pressure of less than 15 mmHg, preferably less than 10 mmHg, more preferably less than 1 mmHg, and even less than 0.1 mmHg at 25° C. By way of comparison, water has a vapor pressure of about 24 mmHg at 25° C. Some embodiments of the leaching-reducing agents of the present invention by themselves may be in the form of solids at room temperature. Such materials tend to sublime to some very minor degree, but may be viewed as having a negligible vapor pressure well below 0.1 mmHg at 25° C. for purposes of the present invention.

Substantially nonionic leaching-reducing agents of the present invention may tend to include some nonionic and/or ionic impurities as prepared or as obtained from commercial sources, as the case may be. Taking into account the potential presence of such impurities, preferred substantially nonionic leaching-reducing agents of the present invention are those containing less than 5 weight percent, preferably less than 2 weight percent, and more preferably less than 0.5 weight percent of nonionic and/or ionic impurities. However, so long as at least one such substantially nonionic substance is used to help protect against leaching, preservative compositions optionally may include one or more ionic species if desired for a variety of purposes. Examples of such ionic species include metal salts, quaternary ammonium salts, other inorganic and/or organic salts, combinations of these, and the like, such as the polymeric quaternary ammonium borates containing PEG blocks described in U.S. Pat. Nos. 5,304,237 and 5,874,025.

In addition to the combination of characteristics mentioned above, preferred leaching reducing agents may also have one or more additional characteristics, either singly or in combination, to further enhance leaching protection. For instance, in some embodiments, it is preferred that the leaching reducing agents are substantially neutral. As used herein, “substantially neutral” means that a solution of 0.5 grams, preferably 1.0 grams, or more preferably 2.0 grams, of the agent or agent(s) dissolved in 100 ml of distilled water has a pH in the range of from about 4 to about 10, preferably from about 5 to about 9, more preferably about 6 to about 8 at 25° C. When a single agent is to be used, the single agent to be used is dissolved in the water to assess pH characteristics. When a mixture of two or more agents are to be used, an appropriate sample of the mixture in the intended proportions to be used is dissolved in the water to assess pH characteristics.

As another optional, desirable characteristic, preferred leaching-reducing agents are those including at least about 4 weight percent, more preferably at least about 4 to about 55 weight percent, and even more preferably at least about 20 to about 45 weight percent oxygen. Examples of these preferred agents include (poly)ethers and/or nonionic surfactants including one or more oxyalkylene units in the backbone and/or as substituents of the molecule. As used herein, the term “(poly)” with respect to an ether indicates that the ether may have one or more oxyalkylene units. The term “poly” without parentheses indicates that the material includes two or more oxyalkylene repeating units, which may be the same or different. In some embodiments, the ingredients that help to improve leaching resistance comprise a combination of a (poly)ether and a nonionic surfactant incorporating one or more of such oxyalkylene groups, respectively. Representative embodiments of (poly)ethers of the present invention comprise one or more linear, branched, and/or cyclic, divalent oxyalkylene repeating units, or combinations of these. The (poly)ethers may be homopolymers or copolymers of two or more copolymerizable materials. If made from two or more copolymerizable materials, the different materials may be incorporated into the (poly)ether randomly or in blocks.

In the practice of the present invention, a divalent, oxyalkylene unit generally has the formula —RO—, wherein R is any straight, branched, or cyclic alkylene or aralkylene, divalent moiety often including from 1 to 10, desirably 1 to 5, more desirably 1 to 3 carbon atoms. Repeating units with larger numbers of carbon atoms may be incorporated into the (poly)ether if desired. However, if the units include too many carbon atoms, or if the (poly)ether includes too large a percentage of repeating units having a relatively large number of carbon atoms, or if the agent is too large, the water solubility of and/or leaching protection provided by the (poly)ether may suffer. Examples include —CH₂O—, —CH₂CH₂O—, —CH₂CH₂CH₂O—, —CH₂CH(CH₃)O—, —CH(CH₃)CH₂O—, —CH₂CH(CH₂CH₃)O—, —CH(CH₂CH₃)CH₂O—, —CH₂CH(CH₃)CH₂O—, —CH(CH₃)CH₂CH₂O—, —CH₂CH₂CH(CH₃)O—, —CH₂CH(CH₂CH₃)CH₂O—, —CH(CH₂CH₃)CH₂CH₂O—, —CH₂CH₂CH(CH₂CH₃)O—, additional variations in which more than one substituent of the oxyalkylene backbone is an alkyl moiety, combinations of these, and the like. The (poly)ethers desirably have terminal groups selected from H, alkyl of 1 to 12 carbon atoms; alkoxy of 1 to 12 carbon atoms; and combinations of these. Often, a commercially available product will include more than one kind of —RO— moiety within individual molecules in those embodiments when the number of —RO— repeating units is greater than one on average. Additionally, commercially available products may include a population distribution of different (poly)ether molecules.

Suitable (poly)ethers are often commercially available as a mixture containing a distribution of (poly)ether polymers with varying number of repeating units and a corresponding variation in molecular weight. Preferred (poly)ether populations of this sort generally may have an average of at least two and preferably from about 1 to about 3000 of these divalent, oxyalkylene repeating units. In more preferred embodiments, the (poly)ethers have a sufficient number of these repeating units such that the (poly)ether material has a weight average molecular weight in the range from at least about 100 to about 50,000, preferably from about 300 to about 30,000, more preferably from about 500 to about 20,000.

The (poly)ether preferably includes at least one (poly)ethylene glycol (PEG). A PEG is a linear (poly)ether polymer incorporating two or more oxyethylene (EO) repeating units and may be represented by the formula

R¹O—(CH₂CH₂O)ₙ—R²

wherein each of R¹ and R² independently is H or straight, branched, or cyclic alkyl, preferably H or alkyl of 1 to 12 carbon atoms, often 1 to 3 carbon atoms; and n is 1 to 3000 and preferably is a number such that the PEG has a weight average molecular weight in the range of from at least about 100 to about 50,000, preferably from about 300 to about 30,000, more preferably from about 500 to about 20,000.

Another class of (poly)ether materials that would be useful in the practice of the present invention are copolymers at least incorporating one or more oxyethylene and one or more oxypropylene (PO) repeating units according to the formula

R³O—(CH(CH₃)CH₂O)ₘ—(CH₂CH₂O)ₙ—R⁴

wherein each of R³ and R⁴ independently is H or straight, branched, or cyclic alkyl, preferably H or alkyl of 1 to 12 carbon atoms, often 1 to 3 carbon atoms; m is 1 to 3000; n is 1 to 3000; and m+n preferably is a number such that the PEG has a weight average molecular weight in the range of from at least about 100 to about 50,000, preferably from about 300 to about 30,000, more preferably from about 500 to about 20,000. Desirably, the ratio of m to n may be in the range from about 1:4 to about 4:1, preferably about 1:1.5 to 1.5:1. In this formula, any other isomer(s) of oxypropylene may be present.

Optionally, in addition to the oxyalkylene units, any (poly)ethers used in the practice of the present invention may further incorporate up to 70 weight percent, desirably up to 25 weight percent, more desirably up to 10 weight percent, and even more desirably up to 2 weight percent of other copolymerizable materials. Examples of such other materials are monomers that include free radically polymerizable functionality such as carbon-carbon double bonds. These materials include monomers such as olefins (ethylene, propylene, butadiene, etc.), (meth)acrylates, styrene-type materials, combinations of these, and the like.

Methods for preparing (poly)ether polymers, including PEG polymers and copolymers of EO and PO are known to those skilled in the art. In addition, the starting materials, often including EO, PO, butanol, glycerol, and hydrogen, are commercially available.

Specific examples of commercially available (poly)ether materials are the CARBOWAX PEG 8000 (weight average molecular weight of about 8000) and the CARBOWAX PEG 1000 (weight average molecular weight of about 1000) polyethylene glycol products commercially available from The Dow Chemical Co. Other examples include glycol ethers such as butoxy triglycol, tripropylene glycol butyl ether, tetraethylene glycol, as well as the glycol ethers available under the trade designation CELLOSOLVE (e.g., Butyl CELLOSOLVE Solvent and Hexyl CELLOSOLVE Solvent) from The Dow Chemical Co.

The amount of the leaching reducing agent incorporated into the preservative composition may vary over a wide range. Representative embodiments may include from about 0.01 to about 200, desirably 0.5 to about 50 parts by weight of the leaching reducing agent per one part by weight of the metal biocide. As is the case above in calculating the weight percent of metal biocide in the composition, the relative parts by weight of the leaching reducing agent relative to the metal(s) is based upon the weight(s) of the metal(s) themselves without inclusion of the weight of other species that might be included with the metal(s) in the metal source(s).

The leaching-reducing agent may also be in the form of, or further include in combination with another agent, one or more nonionic surfactants to help promote leaching resistance. In particular, embodiments of preservative compositions including both (poly)ether and a nonionic surfactant demonstrate excellent leaching resistance, even when only a relative minor proportion of the nonionic surfactant is used relative to the (poly)ether. Nonionic surfactants refer to compounds having at least one hydrophilic moiety coupled to at least one hydrophobic moiety wherein the surfactant carries no discrete cationic or anionic charge when dissolved or dispersed in the preservative composition.

A wide range of nonionic surfactants may be used. In preferred embodiments, the hydrophilicity of the nonionic surfactant is provided by a polyoxyalkylene moiety of the formula —(R⁵O)_{w}— wherein R⁵ is alkylene of 1 to 5 carbon atoms, particularly

—CH₂— (methylene), —CH₂CH₂— (ethylene), propylene, isopropylene, butylene, or isobutylene; and w is often 1 to about 100. R⁵ preferably is ethylene, propylene, or isopropylene. This polyoxyalkylene moiety is capable of strong hydrogen bonding with water, providing the desired hydrophilic characteristics.

The hydrophobicity of the nonionic surfactant is generally provided via a nonpolar moiety coupled to the hydrophilic moiety. Nonpolar desirably means that the moiety includes at least 6 carbon atoms to 100 carbon atoms, preferably at least 10 carbon atoms to 100 carbon atoms; and that there are no more than 2 hetero atoms such as O, S, N, P or the like per 6 carbon atoms, preferably per 10 carbon atoms, more preferably per 15 carbon atoms. In representative embodiments, the hydrophobic moiety is linear, straight, or cyclic alkyl, aryl, aralkyl; or alcohol. Preferred hydroxyl moieties are secondary.

A representative embodiment of a nonionic surfactant is an adduct of an E0 or an EO/PO (poly)ether and an alcohol, desirably a secondary alcohol. Such an adduct may have the following formula:

R⁶O—(R⁷O)ₚ—R⁹

wherein R⁶ is a straight, branched, or linear nonpolar group, cyclic or aryl of 10 to 100, preferably 10 to 50 carbon atoms; each R⁷ is independently an alkylene moiety of 1 to 4 carbon atoms, preferably 2 to 3 carbon atoms, and R⁹ is H or a monovalent moiety comprising 1 to 10 carbon atoms, preferably 1 to 5 carbon atoms; and p is 1 to 200. Particularly preferred embodiments of such an adduct independently have the formulae

R¹⁰O—(CH₂CH₂O)ₖ—(CH(CH₃)CH₂O)_{q}—H

R¹⁰O—(CH₂CH₂O)ₖ—(CH₂CH(CH₃)O)_{q}—H

R¹⁰O—(CH₂CH₂O)ₖ—(CH(CH₂CH₃)CH₂O)_{q}—H

R¹⁰O—(CH₂CH₂O)ₖ—(CH₂CH(CH₂CH₃)O)_{q}—H

wherein each R¹⁰ independently is a hydrocarbon group of 10 to 50 carbon atoms; each k independently is 0 to 80; each q independently is 0 to 40 with the proviso that k+q is greater than or equal to 1. Also included are variants in which an adduct includes a mixture if branched oxyalkylene units contributing towards the total number of q repeating units or variants of these branched oxyalkylene units including two or more pendant alkyl substituents from one or more carbon atoms also contributing to the total number of q repeating units. Often, a commercially available product will include a population distribution of such adducts such that the values for molecular weight, k and q may be expressed as an average. In such mixtures, molecular weight refers to weight average molecular weight throughout this specification unless otherwise expressly noted.

Any amount of nonionic surfactant that is effective to help reduce leaching may be used in the preservative composition. It has been found, however, that leaching resistance is enhanced if the weight ratio of the (poly)ether to the nonionic surfactant is greater than about 1. Accordingly, the weight ratio of the (poly)ether to the nonionic surfactant is greater than 1:1, preferably from about 2:1 to about 50:1, more preferably from about 3:1 to about 20:1.

The preservative compositions may incorporate one or more additional ingredients to further enhance the performance of the compositions. For example, metal biocides such as copper may not have as full a biocidal spectrum against microbes, fungi, pests, etc., as might be desired. Accordingly, one or more additional co-biocides may be incorporated into the preservative compositions in order to provide a fuller biocidal range. Additional co-biocides may include one or more of fungicidal, insecticidal, moldicidal, bactericidal, algaecidal biocides, and/or the like. These co-biocide(s) can be water soluble, partially water soluble, or water insoluble. If partially insoluble or insoluble, dispersants or chelating agents may be used to help disperse these in the preservative compositions.

Thus, a wide range of inorganic and/or organic biocides may be used in accordance with conventional practices. Extensive lists of suitable biocides are provided in the patent literature, including in U.S. Pat. No. 5,874,025; and U.S. Pat. Pub. Nos. 2006/0086284, 2006/0162611, 2005/02566026, and 2005/0249812. The respective entireties of these patent documents are incorporated herein by reference for all purposes. Particularly preferred co-biocides include quaternary ammonium salts and the azole materials, including triazoles and imidazoles. Benzalkonium chloride or carbonate is one preferred quaternary ammonium salt; didecyldimethylammonium chloride or carbonate is another commonly used quaternary ammonium salt. Exemplary azoles include tebuconazole and propiconazole.

Other optional ingredients may also be beneficially used in the preservative composition in accordance with conventional practices. For example, during the course of manufacture, if metal vessels may be used to prepare, transport, store, or otherwise contact the composition, the compositions may include a corrosion inhibitor. Boron containing inhibitors such as boric acid used in corrosion inhibiting amounts have been found to be suitable. In addition to water, the liquid carrier of the preservative compositions may further include one or more optional solvents to help dissolve or disperse other composition ingredients. Such additional solvents are either fully miscible with water or are used in sparing amounts when it is desired to avoid phase separation among the components. Examples of such optional solvents include alcohols such as ethanol and isopropanol, tetrahydrofuran, acetonitrile, combinations of these, and the like. Other adjuvants include dispersants, emulsifiers, binders, fixatives, water repellants, coloring agents, antioxidants, ultraviolet stabilizers, emulsifiers, antistatic agents, desiccants; precipitation inhibitors; buffers; fire retardants; combinations of these, and the like used in accordance with conventional practices.

The compositions may be prepared according to a variety of methods. It is beneficial to first combine the metal source and the complexing agent at generally the desired concentration in water with mixing to form the metal complex. Then, additional ingredients may be combined with the complex in one or more stages. According to one mode of practice, the reaction to form the metal complex may be carried out below, at, or above room temperature. It may be desirable to avoid heating the reaction mixture too much to avoid thermal degradation of the complexing agent.

The preservative compositions may be prepared, stored, and/or shipped initially as one or more concentrates (e.g., one part or two part concentrates) if desired. The concentrate(s) can then be combined if more than one is used and diluted for treatment of biodegradable products. A wide range of concentration/dilution schedules may be used. For example, the concentrate may be at least 5, desirably 5 to 500, more desirably 5 to 50, and most desirably 10 to 25 times more concentrated than the diluted form of the composition that will be used to actually treat biodegradable products. At the time of dilution, a wide range of liquids can be used for dilution. Preferred dilution liquids include water and/or water miscible liquids. Water immiscible materials should be used sparingly so as to avoid phase separation. For economical reasons, using water by itself would be suitable in most instances. If the dilution water includes species that might induce undue precipitation of the metal biocide(s) or other ingredient(s) of the compositions, it may be desirable to treat the water prior to dilution. Representative examples of treatments include one or more of physical or chemical filtering, extraction, distillation, reverse osmosis, softening, other mass transfer techniques for removing impurities, and the like. Precipitation inhibitors may also be included in the composition, if desired.

Concentrates may be prepared in accordance with conventional methodologies, such as according to the methodology of AWPA Standard P5-02 (referring to standard P5 issued in 2002). The anti-leaching agent(s) may then be added to the concentrate at any time prior to, during, and/or after dilution to the final concentration that will be used to carry out the impregnation treatment. The agent(s) can be directly added to the concentrate or pre-dissolved in a suitable liquid carrier (often water) and then added to the concentrate. The anti-leaching agent(s) may be added quickly or slowly over a time period extending from ten seconds to 8 hours. Whether added quickly or slowly, the ingredients desirably are added with thorough mixing. Moderate heating may be used to help obtain a homogeneous composition. Because concentrates generally have long shelf-life, the concentrates can be stored for considerable periods of time before addition of the anti-leaching agent(s).

The present invention also involves the appreciation that biodegradable substrates, and wood products in particular, tend to have a saturation level for impregnation by water-soluble, metal-containing biocides. Wood products, consequently, tend to have a finite capacity to be strongly associated with the active metal species in preservative compositions. Excess added to the wood product beyond this will be much more prone to leaching and offers little long term protection, if any, as a consequence. Applying this concept, particularly in combination with the ingredients that improve leaching resistance, allows a high level of long-term decay protection to be achieved using more dilute treatment regimes than conventionally would be associated much more concentrated treatment regimes.

In some modes of practice, consequently, aspects of the present invention involve carrying out impregnation with atypically dilute preservative compositions, particularly those that impregnate a substrate without exceeding the saturation level of the substrate for retaining metal-containing biocides contained in the compositions. This practice, in and of itself, helps to reduce leaching by reducing or avoiding excess metal-containing biocide that might be more prone to leach. In particularly preferred embodiments, these dilute preservative compositions also include one or more anti-leaching agents of the present invention to further enhance protection against leaching. In accordance with such modes of practice, the preservative composition at the time of treating the substrate desirably has a concentration of metal biocide of less than about 0.2, preferably less than about 0.1, more preferably less than about 0.06, and even more preferably less than about 0.04 metal atom equivalents per liter. In such embodiments, it is desirable if the concentration of the metal biocide in the treating solution is at least about 0.01 metal atom equivalents per liter to maintain an efficient level of biological efficacy. Such treating solutions are easily obtained by dilution of a concentrate or concentrate components.

For example, copper basic carbonate Cu₂(OH)₂CO₃ would have two metal atom equivalents of Cu per mole of copper basic carbonate, whereas copper carbonate CuCO₃ has one metal atom equivalent of Cu per mol of copper carbonate. Thus a one liter solution containing 0.06 mol of copper basic carbonate would include 0.12 metal atom equivalents of Cu per liter. A one-liter solution containing 0.06 mol of copper carbonate would include 0.06 metal atom equivalents of Cu.

The recognition that dilute treatments can protect biodegradable substrates without the excessive leaching or environmental impact that could be associated with using more concentrated treatments can be used practically to develop effective preservative treatment methodologies. For example, according to one protocol, information can be provided that is indicative of an impregnation level at which the biodegradable substrate retains a metal-containing biocide. In one form, this information may be in the form of the degree to which a metal biocide such as Cu leaches from treated substrate samples as a function of the concentration of the metal biocide in the treating solution. Indeed, the Examples provide this kind of data and further show how dilution reduces leaching from samples more than would be expected from the dilution alone. Optionally, this information may further include bioefficacy data as a function of dilution. The information can then be used to prepare a preservative composition comprising the metal-containing biocide.

For instance, the data can be examined to determine that a particular dilution level provides a comparable level of bioprotection against decay with much less leaching than a higher concentration. A preservative composition can then be prepared corresponding to this particular dilution level directly, dilution of a concentrate, or other suitable method. The preservative composition is then caused to be used to treat a biodegradable substrate.

The preservative compositions of the present invention of any embodiments can be used to treat a wide range of natural and synthetic biodegradable products in a wide range of applications. Examples of cellulosic embodiments of biodegradable products include but are not limited to paper, cardboard, rope, veneer, lumber, manufactured timbers, cellulosic composites, engineered lumber, and sheet goods such as plywood, hardboard, particleboard, chipboard, fiberboard, strandboard, paneling, and the like. Representative end uses include residential, commercial, industrial, and marine interior or exterior applications such as construction lumber, trim, siding, decking, beams, railway sleepers, railroad ties, bridge components, jetties, wooden vehicles, docks, claddings, boxes, pallets, telephone poles, windows, doors, boats and ships, sheathing, foundation piles, posts, fences, marina structures, and other structures vulnerable to decay due to one or more of insects, fungi, microbes, and/or weathering.

The preservative compositions can be used to treat biodegradable products using a variety of treatment methods. These include manual methods such as spraying, brushing, immersion, pouring processes such as curtain coating, and the like. These also include automated methods such as pressurized impregnation, alternating pressure impregnation, vacuum impregnation, double vacuum impregnation, and the like. For synthetic wood products, the preservative compositions can be intermixed with other components used to form the products and/or used to impregnate components of such products prior to assembly. According to one illustrative method, a biodegradable product may be treated in accordance with AWPA T1-02 (commercial treating standard from year 2002).

Optionally, recognizing that a significant portion of leaching occurs initially from wood products with respect to excess metal biocide present above the saturation level, a treated wood product can be pre-leached, such as by contact with water for a suitable period, if desired. Such pre-leaching can occur via spraying, immersion, or the like. Pre-leaching may occur under ambient conditions or may occur at elevated or reduced pressures and/or elevated or reduced temperatures. Agitation may be used to accelerate the pre-leaching effect. Illustrative pre-leaching time periods may range from 20 seconds to ten days. The leaching performance of compositions of the present invention may be evaluated according to different test methodologies. One current, widely accepted test methodology is set forth in AWPA E11-97. However, this test methodology requires extensive time (over 300 hours) and expense to complete just one test. These extensive time and expense burdens practically limit the number and rate of testing that can be carried out in an economically rationale fashion. Consequently, these burdens have limited acquisition of knowledge and slowed development in the field of preservative compositions for wood products.

Advantageously, another aspect of the present invention provides an improved method (hereinafter referred to as the Accelerated Leaching Test) for evaluating leaching characteristics of these compositions from cellulosic substrates. The test is rapid and inexpensive. The Accelerated Leaching Test makes it economical to gather data for multitudes of samples in a short time at relatively minor expense. Leaching data obtained from the Accelerated Leaching Test has been correlated to the more burdensome industry standard test of AWPA E11-97 and a very high correlation has been found based on the same rankings of samples according to percent metal leached. The Accelerated Leaching Test has greatly expanded the opportunity to acquire leaching knowledge about preservative compositions at an increased rate. Use of the method to acquire leaching data is a significant advantage.

According to the method, a sample of the treating composition under investigation is used to impregnate a cellulosic substrate. The treating composition may incorporate a metal biocide such as copper, and this accelerated test may be used to evaluate how the copper leaches from an impregnated sample. Sample preparation and impregnation may occur according to AWPA standard P5-02. The impregnated sample blocks are then allowed to dry overnight at room temperature followed by placing in an oven at 35° C. for 5 days to help fix a portion of one or more components such as the metal biocide directly or indirectly to the substrate. The term “fix” means chemically and or physically bonding the component to the substrate. Fixation, for instance, will tend to occur naturally when a metal-containing biocide is in contact with a dry substrate over a period of time, but fixation is accelerated by a thermal treatment.

After fixation, 6 of the impregnated sample blocks are immersed in 0.300 liters of distilled water for a period of 30 minutes to 72 hours at 25° C. with agitation to assess leaching. Agitation is provided by Innova 4000 Incubator Shaker. The agitation is an important feature that helps to accelerate the testing progress. As a result of agitating the immersed sample during the leaching period, the leaching characteristics of the tested sample can be correlated with a high degree of confidence to the leaching characteristics of corresponding impregnated products in the field. At one or more times such as prior to the beginning of the test, one or more times during, and/or after the leaching period, the water may be tested for Cu concentration to assess the degree of leaching from the sample. Using the Accelerated Leaching Test has led to significant gains of knowledge. In particular, the test has been used to show that wood products have a saturation point for impregnation with a metal biocide such as copper. In practical effect, the data indicates that wood products have a finite capacity to bind a Cu impregnant relatively strongly. Any excess Cu impregnant beyond the saturation level will be bound less strongly and will be much more prone to leach in the field. Saturation is shown by various data. One class of supporting data shows that most leaching occurs very quickly, within the first 22 hours in real time. Thereafter, the rate of leaching slows tremendously and the Cu content of the wood product is much more stable. This is consistent with the view that excess Cu beyond the saturation level is held loosely and will leach out of wood relatively quickly.

The appreciation that there is a saturation effect with respect to metal biocides such as copper means that leaching can be reduced not only by using additives such as a (poly)ether or a (poly)ether in combination with a nonionic surfactant as taught herein, but also by lower usage rates. Further, the appreciation that there is a saturation effect means that lower usage rates can be used without unduly reducing biocidal activity. One can use less Cu impregnant, because any excess beyond the saturation level will tend to be unavailable for long term protection. In other words, practice of the present invention leads to the appreciation that less active material can be used to achieve the same level of performance provided by using too much active material. A simple way to reduce usage rates is to use more dilute solutions during impregnation. Significantly, this will simplify manufacture, shipping, and treatment and reduce costs while also protecting the environment.

Another advantage resulting from the appreciation of the saturation concept relates to the realization that ACQ concentrates can be diluted to a greater extent and still provide excellent preservation of substrates. As a consequence, a given amount of ACQ can be diluted more and thereby used to treat more substrate per unit volume of the original concentrate. The saturation concept thus significantly extends the usage rate of the concentrate.

Note that the optimum impregnation level might not be at the saturation level, but rather may be some fraction of the saturation level. Without wishing to be bound by theory, this is due to the belief that a metal biocide such as Cu may have a tendency to migrate from one fixed site on the substrate to another over time. It is also believed that this mobility of the Cu contributes to bioefficacy to some degree. By operating below the saturation level, substrate capacity is provided to accommodate this migration effect.

The various aspects of the present invention will now be described with respect to the following illustrative examples. In the following examples all percentages and parts are by weight unless otherwise expressly indicated.

### Example 1

### Exemplary Preparation of Wood Treating Concentrate

3000 grams of Wood Treating Concentrate A are prepared in a one-gallon container using the following ingredients:

| | |
|---|---|
| 765 grams | Monoethanolamine (MEA) |
| 1554 grams | Distilled Water |
| 384 grams | Copper Basic Carbonate |
| 159 grams | Boric Acid |
| 138 grams | FLUKA 12060 (benzalkonium chloride) |

The procedure involves adding the ingredients one at a time in the listed order with sufficient mixing with each addition to ensure complete dissolution before adding the next ingredient.

### Preparation of an Exemplary Wood Treating Solution

An exemplary treating solution (“Wood Treating Solution A”) is prepared by placing 270 grams of the Wood Treating Concentrate A in a one-gallon container, adding 1620 grams of distilled water, and mixing well. This results in a 6 to 1 dilution of water to concentrate. While maintaining stirring, CO₂ in the form of dry ice is added to the solution until a pH between 8.8 to 9.2 is achieved. Typically, 16 to 25 grams of dry ice is required.

### Conditioning of Wood Blocks

Cubed, wood blocks (¾ inch) are cut from a southern yellow pine, select grade board. The blocks are free of knots or other imperfections and contain 3 to 6 grain lines. Blocks weighing between 3.3 and 3.5 grams are selected for testing, placed in a constant humidity chamber, and conditioned for a time period ranging from overnight to 3 days. The relative humidity is maintained between 50% to 60%.

### Treating of the Wood Blocks

Nine conditioned blocks, having weight standard deviation off 0.2 grams, are selected for treatment. The blocks are placed in the bottom a 500 ml Erlenmeyer flask with side arm. A perforated flexible plastic weighing dish is wedged on top of the blocks to keep them submerged when the Wood Treating Solution A is later added. A 250 ml pressure-equalizing addition funnel containing 200 ml of Wood Treating Solution A is connected to the top of the Erlenmeyer flask. The flask side arm is connected to house vacuum. The vacuum is applied for 20 minutes while being maintained at 250±5 mmHg. After the 20 minutes the Wood Treating Solution A is added to the blocks and then the vacuum is turned off. The blocks remain in the Wood Treating, Solution A for 30 minutes. After the 30 minutes the solution is decanted and the blocks are removed from the container. The excess liquid is removed from the blocks by dabbing each side of each block on a paper towel. Each block is then weighed and is placed on a rack to dry. After each set of blocks dries overnight at room temperature they are place in a forced air convection oven for five days with the temperature maintained at 35±1° C. A container of distilled water is placed in the bottom of the oven to help control the rate of drying of the blocks.

### Copper Leaching Testing

After the five days the blocks are removed from the oven. The six blocks within a set of nine having the closest weights of absorbed treating solution are placed in a one-pint jar and 300 ml of distilled water is added. The jar containing the six blocks is placed on an orbital shaker and is agitated at 150 rpm for 4 hours and then 130 rpm for 18 hours.

After removing from the shaker, a sample of the resultant leaching solution is filtered using a 45 μm nylon membrane to remove suspended fine wood particles and is analyzed for copper by ICP (Inductively Coupled Plasma). The amount of Cu found in the leaching solution, in ppm, is indicative of the amount of copper that leaches from the blocks into the solution. Higher ppm values indicate that more leaching occurs.

The procedures described in this Example are repeated for a total of 8 sample sets of six blocks. The results are shown in Table 1. The value under “PPM Copper” represents the amount of copper (on a weight basis) in the liquid from all six corresponding blocks. Note that none of these samples includes additives to protect against copper leaching in accordance with the present invention. The variation of copper leaching results is less than 5% through all these samples.

TABLE 1
Copper Leaching from 6:1 Dilution
Standards (Concentration of metal biocide is
about 0.16 metal atom equivalents per liter of
treating solution)

| Sample | PPM Copper |
|---|---|
| 1a | 305 |
| 1b | 346 |
| 1c | 310 |
| 1d | 319 |
| 1e | 315 |
| 1f | 327 |
| 1g | 325 |
| 1h | 329 |
| Average | 322 |
| Standard Deviation | +/−13 ppm |

### Example 2

### Preparation of Wood Treating Solutions with Additives

This Example shows how using additives of the present invention in wood treating solutions can dramatically reduce copper leaching. A series of the Wood Treating Solutions is prepared using a different additive(s) and/or additive concentration for each. The additives used and their respective abbreviations are shown below:

| Additive | Abbreviation |
|---|---|
| CARBOWAX | PEG-8000 |
| Polythethylene Glycol PEG- | |
| 8000 | |
| TERGITOL 15-S-40 | 15-S-40 |
| Surfactant | |
| CARBOWAX Polyethylene | PEG-1000 |
| Glycol PEG-1000 | |
| Butyl CELLOSOLVE | BuCs |
| Solvent | |
| Butoxy Triglycol | BTG |
| Triethanolamine | TEA |
| Ethylenediamine | EDA |
| Tetraethylene Glycol | TTEG |
| TERGITOL TMN-10 | TMN-10 |
| Surfactant | |
| Methanol | MeOH |
| Isopropanol | IPA |
| Hexyl CELLOSOLVE | HxCs |
| Solvent | |
| Poly PG (Molecular wt. 450) | Poly PG-450 |
| 1-Pentanol | Pentanol |
| Tripropylene Glycol Butyl | TPB |
| Ether | |

To prepare Samples incorporating one or more of these additives, the desired additive(s) are blended into the Wood Treating Solution A after this solution is prepared by diluting the Wood Treating Concentrate A. The blending procedure involves placing the appropriate quantity of additive(s) in an 8-ounce container, adding 200 grams of the 6 to 1 dilution Standard Treating Solution, and stirring until completely dissolved. Wood blocks are conditioned, treated, and subjected to leaching testing in accordance with the procedures used in Example 1 (For instance, nine blocks are conditioned and treated, and then six of these are selected for leaching testing).

For each sample, the additive(s), the weight percent of each individual additive added to the Wood Treating Solution A based upon the total weight of the resultant Wood Treating Solution A after adding the additive, total weight percent of all additives added to the Solution A, and the amount of Cu leaching after 22 hours, in ppm, are given in Table 2. All examples with nonionic, water soluble additives having lower vapor pressures than water and with molecular weights over 100 show reduced copper leaching relative to the control samples used in Example 1.

Examples 2u and 2v illustrate the increased copper leaching observed with basic (non-neutral), complexing amines. Example 2ff, (1% methanol+1% pentanol) show that nonionic additives with molecular weights less than 100 show little appreciable impact on lowering copper leaching. It is also noted from examples 2a-2t that nonionic surfactants and PEG's are especially effective at lowering copper leaching, both alone and in combination. In the following table, weight percents are based upon the total weight of the resultant solution.

TABLE 2
Copper Leaching from 6:1 ACQ Solutions with Various Additives

| Sample | PEG-8000 | 15-S-40 | | | % Total | PPM Cu |
|---|---|---|---|---|---|---|
| No. | (%) | (%) | (%) Additive 1 | (%) Additive 2 | Additive | Leached |
| 2a | | 0.2 | | | 0.2 | 293 |
| 2b | | 0.6 | | | 0.6 | 287 |
| 2c | | 1.0 | | | 1 | 268 |
| 2d | 0.8 | 0.2 | | | 1 | 273 |
| 2e | 2.66 | 0.33 | | | 3 | 199 |
| 2f | 0.5 | 0.5 | | | 1 | 274 |
| 2g | 2.33 | 0.66 | | | 3 | 195 |
| 2h | 1 | 1 | 1 BuCs | | 3 | 234 |
| 2i | 0.4 | 0.2 | | | 0.6 | 264 |
| 2j | 0.3 | 0.3 | | | 0.6 | 282 |
| 2k | 1.8 | 0.2 | | | 2 | 226 |
| 2l | | 1 | 1 BTG | | 2 | 266 |
| 2m | 1.5 | 0.5 | | | 2 | 216 |
| 2n | 0.5 | 1.5 | | | 2 | 227 |
| 2o | 3 | | | | 3 | 209 |
| 2p | 2 | 1 | | | 3 | 198 |
| 2q | 4.5 | | | | 4.5 | 167 |
| 2r | | 2 | | | 2 | 236 |
| 2s | | 1 | 2 PEG1000 | | 3 | 217 |
| 2t | 0.75 | 0.5 | 0.75 PEG1000 | | 2 | 202 |
| 2u | | | 5 TEA | | 5 | 563 |
| 2v | | | 3 EDA | | 3 | 587 |
| 2w | 0.5 | 0.5 | 0.5 BuCs | | 1.5 | 281 |
| 2x | | | 10 BuCs | | 10 | 259 |
| 2y | | | 20 TTEG | | 20 | 130 |
| 2z | | | 1.0 TMN-10 | 1 PEG-1000 | 2 | 243 |
| 2aa | | | 5 MeOH | 5 IPA | 10 | 233 |
| 2bb | | 0.5 | 4.0 PEG 1000 | | 4.5 | 214 |
| 2cc | | | 1 HxCs | 1 BTG | 2 | 323 |
| 2dd | 1 | | 0.5 PEG1000 | 0.5 15-S-7 | 2 | 222 |
| 2ee | | | 1 Poly PG-450 | | | 333 |
| 2ff | | | 1 1-Pentanol | 1 MeOH | | 326 |
| 2gg | | 1 | | 1 MeOH | | 267 |
| 2hh | 1.5 | | | | | 269 |
| 2ii | 0.5 | | | | | 290 |

### Example 3

This Example shows how increased dilution of the Wood Treating Concentrate A impacts how additives of the present invention can protect against Cu leaching. All solution preparation and testing methods are the same as in Example 1 except for the preparation of the Wood Treating Solution A. For this Example the Wood Treating Solution A is prepared as a 10 to 1 dilution of the Wood Treating Concentrate A with distilled water. Also, additives of the present invention are incorporated into the treating solutions as described in Example 2. Copper leaching results of samples of the present invention along with two control standards (no additives added to protect against Cu leaching) are shown in Table 3. Weight percents are based upon the total weight of the resultant solution.

TABLE 3
Percent by Weight of Each Additive with 10:1 Dilution.
(Concentration of metal biocide is about 0.10 metal atom equivalents
per liter of treating solution; which represents about 38% reduction
in metal biocide concentration relative to Example 1)

| | | | Leached | Reduction in copper |
|---|---|---|---|---|
| | | | Copper | leaching relative to |
| Sample | % PEG-8000 | % 15-S-40 | (ppm) | Example 1 average. |
| Standard A | | | 140 | 57% |
| 3a | 1.5 | | 101 | 69% |
| 3b | 3.0 | | 86 | 73% |
| 3c | 4.5 | | 72 | 78% |
| 3d | 1.0 | 0.5 | 85 | 74% |
| Standard B | | | 130 | 60% |

Average ppm Copper for Standards = 135 ± 7.1 ppm

In those samples without additives of the present invention, Table 2 shows that leaching was reduced by about 57% to 60% even though concentration of metal biocide was reduced by only 38% relative to Example 1. The larger percentage reduction in leaching is believed to be due, at least in part, to the saturation effect discussed above. Since a lesser excess of the metal biocide is present when using the more dilute treatment solution, a lesser excess is present to leach more readily.

The samples with additives of the present invention show how the reduction in leaching is even greater when additives of the present invention are used. These same trends are observed with respect to Tables 4 and 5, below.

### Example 4

This Example also shows how increased dilution of the Wood Treating Concentrate A impacts how additives of the present invention can protect against Cu leaching. All solution preparation and testing methods are the same as in Example 3 except the Wood Treating Solution A is prepared as a 17 to 1 dilution of the Wood Treating Concentrate A with distilled water. Copper leaching results for samples of the present invention along with those of two standards are shown in Table 4. Weight percents are based upon the total weight of the resultant solution.

TABLE 4
Percent by Weight of Each
Additive with 17:1 Dilution
(Concentration of metal biocide is about
0.064 metal atom equivalents per liter of
treating solution; which represents
about 64% reduction in copper loading
relative to Example 1)

| | | | Copper | Reduction in copper |
|---|---|---|---|---|
| | | | leaching | leaching relative to |
| Sample | % PEG-8000 | % 15-S-40 | (ppm) | Example 1 average. |
| Standard A | | | 56 | 83% |
| 4a | 1.5 | | 39 | 88% |
| 4b | 3.0 | | 29 | 91% |
| 4c | 4.5 | | 28 | 91% |
| 4d | 1.0 | 0.5 | 42 | 87% |
| Standard B | | | 60 | 81% |

Average ppm Copper for Standards = 58 ± 2.8 ppm

### Example 5

This Example also shows how increased dilution of the Wood Treating Concentrate A impacts how additives of the present invention can protect against Cu leaching. All solution preparation and testing methods are the same as Example 3 except for the preparation of the Wood Treating Solution A. For this Example the Wood Treating Solution A is prepared as a 28 to 1 dilution of the Wood Treating Concentrate A with distilled water. Copper leaching results for samples of the present invention along with those of two standards are shown in Table 5. Weight percents are based upon the total weight of the resultant solution.

TABLE 5
Percent by Weight of
Each Additive with 28:1 ACQ
(Concentration of metal biocide
is about 0.040 metal atom
equivalents per liter of treating
solution; which represents
about 77% reduction in copper
loading relative to Example 1.

| | % PEG- | % 15-S- | Copper | Reduction in copper leaching |
|---|---|---|---|---|
| Sample | 8000 | 40 | (ppm) | relative to Example 1 average. |
| Standard A | | | 20 | 94% |
| 5a | 1.5 | | 13 | 96% |
| 5b | 3.0 | | 10 | 97% |
| 5c | 4.5 | | 9 | 97% |
| 5d | 1.0 | 0.5 | 16 | 95% |
| 5e | 0.5 | | 14 | 96% |
| Standard B | | | 18 | 94% |

Average ppm Copper for Standards = 19 ± 1.4 ppm

### Example 6

Eight ACQ-C concentrates are prepared from copper basic carbonate, monoethanolamine, benzalkonium chloride, and boric acid according to AWPA standard P5-02. A PEG and/or nonionic surfactant is added to seven of the samples prior to dilution such that upon dilution to give a treating solution with 0.6 wt % copper, the eight samples have the following compositions (Weight percents are based upon the total weight of the resultant solution):

| | |
|---|---|
| 6a | Standard ACQ-C, no additives |
| 6b | +3 wt % PEG 8000 |
| 6c | +3 wt % 15-S-40 surfactant |
| 6d | +1.5 wt % PEG 8000 |
| 6e | +1.5 wt % 15-S-40 |
| 6f | +1.5 wt % PEG 8000/1.5 wt % 15-S-40 |
| 6g | +1.5 wt % PEG 8000/1.5 wt % 15-S-40 |
| 6h | +2.25 wt % PEG 8000/2.25 wt % 15-S-40 |

In Sample 6g, the concentrate is modified. Rather than using 892 grams of MEA, 844 grams of MEA and 123 grams of triethanolamine (TEA) are used. The pH of the concentrate is also lower, being about 7.8 to 8.0. All other aspects of preparing the concentrate are the same.

Cubes (¾″) of Southern Yellow Pine are prepared according to AWPA E7, then impregnated with the above treating solutions following AWPA E10. After drying and fixation, the blocks are leached in water according to AWPA E11. Table 6 shows the percent copper that was leached from 0-312 hours. Samples 6b and 6c give the best results, that is, 49% and 35% less leaching than 6a (standard). All percents are weight percent based upon the total weight of the resultant solution.

TABLE 6
Percentage of Copper Leached (0-312 hours).

| Sample | Hours | | | | | | | | | | |
|---|---|---|---|---|---|---|---|---|---|---|---|
| ID | 0 | 6 | 24 | 48 | 72 | 96 | 144 | 168 | 216 | 234 | 312 |
| 6a | 9.40% | 11.8% | 13.60% | 14.50% | 15.10% | 15.30% | 15.70% | 15.90% | 16.10% | 16.20% | 16.30% |
| 6b | 2.90% | 4.40% | 5.90% | 6.90% | 7.30% | 7.50% | 7.80% | 8.00% | 8.10% | 8.20% | 8.30% |
| 6c | 4.50% | 6.20% | 7.70% | 8.60% | 9.50% | 9.80% | 10.00% | 10.20% | 10.40% | 10.40% | 10.50% |
| 6d | 6.00% | 7.80% | 9.80% | 10.80% | 11.20% | 11.50% | 11.80% | 12.10% | 12.30% | 12.30% | 12.40% |
| 6e | 4.90% | 6.70% | 8.60% | 9.60% | 10.00% | 10.20% | 10.50% | 10.70% | 10.90% | 11.00% | 11.10% |
| 6f | 5.90% | 8.70% | 11.20% | 12.50% | 13.20% | 13.50% | 13.80% | 14.10% | 14.30% | 14.40% | 14.50% |
| 6g | 7.10% | 9.60% | 12.10% | 13.40% | 13.90% | 14.20% | 14.50% | 14.80% | 15.00% | 15.10% | 15.20% |
| 6h | 3.80% | 6.00% | 8.20% | 9.20% | 9.70% | 9.90% | 10.30% | 10.50% | 10.70% | 10.80% | 10.90% |

### Example 7

The procedures of Example 2 are used with the following exceptions. Southern Yellow Pine blocks are selected randomly and without consideration for wood grain. The water content of the blocks is unknown and no effort is made to control the humidity prior to treatment with preservative. Also, a faster and more vigorous, back and forth agitation (reciprocating motion) is employed for leaching. The above modifications results in a quicker screening of additives that reduce leaching. The results show that the principles of the present invention also provide very effective protection against Cu leaching even when conditions are more challenging and not controlled as closely as in Example 1.

| Sample | | Additive | | |
|---|---|---|---|---|
| No. | | Amount | PPM Cu | Comments |
| 7a | Standard [Average of 7 | 0.0% | 165 | Wood selected had different water |
| | measurements] | | | content and grain resulting in 20% |
| | | | | to 30% lower treating solution |
| | | | | absorbtion than previous |
| | | | | examples! |
| 7b | | | | |
| 7c | Butyl CELLOSOLVE | 10.0% | 69 | Larger amounts of lower molecular |
| | Solvent | | | weight solvents dramatically lower |
| 7d | Tetraethylene Glycol | 20.0% | 76 | Cu leaching. |
| 7e | PEG-1000 + PEG-8000 + | 5.0% | 78 | Demonstrates a variety of |
| | PEG-20,000 + PEG-30,000 | | | polyethylene oxide products are |
| | (1.25/1.25/1.25/1.25) | | | effective in lowering leaching. |
| 7f | 30K MWT Poly EO + PEG- | 2.5% | 91 | |
| | 1000 (1.25/1.25) | | | |
| 7g | PEG-30,000 | 2.0% | 116 | |
| 7h | Heptoxytriglycol | 5.0% | 126 | Lower amounts of lower molecular |
| 7i | Isopropanol | 10.0% | 138 | weight solvents are less effective at |
| 7j | TMN-10 | 2.0% | 149 | lowering Cu leaching. |
| 7k | Dipropylene Glycol | 5.0% | 165 | |
| 7l | Tetraethylene Glycol | 5.0% | 152 | |
| 7m | PEG-60,000 | 1.0% | 232 | |
| 7n | Citric Acid | 1.74% | 351 | |

PEG-1000, PEG-8000, PEG-20,000, PEG-30,000 & PEG-60,000 are polyethylene oxide mixtures with weight average molecular weights of 1000, 8000, 20,000, 30,000 and 60,000, respectively.
TMN-10 = Trimethyl Nonanol 11-mole ethoxylate on average.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An aqueous preservative composition for treating biodegradable substrates, derived from ingredients comprising:
a) a source of a metal biocide;
b) an amount of a complexing agent effective to form a water-soluble complex with at least a portion of the metal biocide; and
c) at least one water soluble, substantially nonionic leaching-reducing agent having a molecular weight of at least about 100 and having vapor pressure less than that of water at 25° C., said composition including an amount of the agent effective to reduce leaching of the complexed metal biocide from a biodegradable substrate impregnated with the composition relative to an otherwise identical composition lacking the agent.

2. The composition of claim 1, wherein the metal biocide comprises Cu.

3. The composition of claim 2, wherein the composition comprises at least one additional biocide selected from the group consisting of an azole and a quaternary ammonium salt.

4. (canceled)

5. The composition of claim 1, wherein the leaching-reducing agent includes at least 10 weight percent oxygen.

6. The composition of claim 5, wherein the leaching-reducing agent comprises one or more oxyalkylene units.

7-9. (canceled)

10. The composition of claim 1, wherein the complexing agent comprises an alkanolamine.

11. (canceled)

12. The composition of claim 1, wherein the leaching-reducing agent comprises a (poly)ethylene glycol having at least one oxyethylene group and including terminal groups selected from H; linear, branched or cyclic alkyl; and combinations of these.

13. (canceled)

14. The composition of claim 12, wherein the (poly)ether has the formula:
R¹O—(CH₂CH₂O)ₙ—R²
wherein each of R¹ and R² independently is H or straight, branched, or cyclic alkyl, preferably H or alkyl of 1 to 12 carbon atoms; and n has an average value such that the (poly)ethylene glycol has a weight average molecular weight in the range of 100 to 50,000.

15-16. (canceled)

17. The composition of claim 12, wherein the leaching-reducing agent further comprises an amount of a nonionic surfactant effective to help reduce the tendency of the copper to leach from a cellulosic substrate impregnated with the composition.

18. The composition of claim 17, wherein the nonionic surfactant is an adduct of a reactant comprising at least one oxyalkylene unit and an alcohol.

19. The composition of claim 18, wherein the alcohol is a secondary alcohol.

20-22. (canceled)

23. An aqueous preservative composition for treating biodegradable substrates, derived from ingredients comprising:
a) a source of a metal biocide;
b) a first water-soluble, substantially nonionic leaching-reducing agent having a molecular weight of at least about 100 and having a vapor pressure less than that of water, said composition including an amount of the first agent effective to reduce leaching of the metal biocide from a biodegradable substrate impregnated with the composition relative to an otherwise identical composition lacking the agent; and
c) a second water soluble, substantially nonionic agent comprising a nonionic surfactant, wherein the weight ratio of the water soluble, substantially nonionic first agent to the nonionic surfactant is greater than 1.

24. The composition of claim 23, wherein the nonionic surfactant comprises a hydrophilic polyoxyalkylene moiety of the formula —(R⁵O)_{w}— wherein each R⁵ independently is an alkylene moiety of 1 to 5 carbon atoms, and w is 1 to about 100.

25. The composition of claim 24, wherein the metal biocide comprises Cu.

26. The composition of claim 23, wherein the nonionic surfactant has the formula
R⁶O—(R⁷O)ₚ—R⁹
wherein R⁶ is a straight, branched, or linear nonpolar group, cyclic or aryl of 10 to 100 carbon atoms; each R⁷ is independently an alkylene moiety of 1 to 4 carbon atoms, R⁹ is H or a monovalent moiety of 1 to 10 carbon atoms, and p is 1 to 200.

27. The composition of claim 26, wherein the nonionic surfactant has the formula
R¹⁰O—(CH₂CH₂O)ₖ—(CH(CH₃)CH₂O)_{q}—H
wherein R¹⁰ is a hydrocarbon group of 10 to 50 carbon atoms; k is 0 to 80; q is 0 to 40 with the proviso that k+q is greater than or equal to 1.

28. (canceled)

29. The composition of claim 23, wherein the first water-soluble, substantially nonionic leaching-reducing agent is a nonionic (poly)ether and the weight ratio of the (poly)ether to the nonionic surfactant is in the range from about 3:1 to about 20:1.

30. (canceled)

31. The composition of claim 29, wherein the nonionic (poly)ether is a polyethylene glycol having a weight average molecular weight in the range of about 300 to about 30,000.

32-36. (canceled)

37. A method of treating a biodegradable substrate, comprising the steps of:
a) providing ingredients comprising a (poly)ether;
b) causing the (poly)ether to be incorporated into a wood treating composition also derived from ingredients comprising Cu and a complexing agent;
c) after adding the (poly)ether, causing the composition to be used to treat the biodegradable substrate.

38. (canceled)

39. The method of claim 37, wherein the ingredients of step (a) further comprise a nonionic surfactant.

40-42. (canceled)
